(19) United States
(12) Patent Application Publication
(10) Pub. No.: US 2024/0319096 A1
(43) Pub. Date: Sep. 26, 2024

(54) FLUORESCENCE MODE FOR WORKPIECE INSPECTION

(71) Applicant: KLA Corporation, Milpitas, CA (US)

(72) Inventors: Grace H. Chen, Los Gatos, CA (US); Xuezhen Wang, Dublin, CA (US); Junjun Shan, San Jose, CA (US); Pradeepkumar Jagadesan, San Jose, CA (US)

(21) Appl. No.: 18/611,299

(22) Filed: Mar. 20, 2024

Related U.S. Application Data
(60) Provisional application No. 63/453,526, filed on Mar. 21, 2023.

(51) Int. Cl. G01N 21/64; G01N 21/88; G01N 21/95

(52) U.S. Cl. CPC G01N 21/645; G01N 21/8806; G01N 21/9501; G01N 2021/6471; G01N 2021/8848

(57) ABSTRACT

A beam of light is directed at a workpiece that includes a low-k dielectric material, which causes fluorescence emission from the low-k dielectric material. The workpiece is imaged during fluorescence emission. The imaging can use an optical filter in an imaging path of the beam of light that selects at least one wavelength from 300 nm to 900 nm.

### CROSS-REFERENCE TO RELATED APPLICATIONS

This application claims priority to the provisional patent application filed Mar. 21, 2023 and assigned U.S. App. No. 63/453,526, the disclosure of which is hereby incorporated by reference.

### FIELD OF THE DISCLOSURE

This disclosure relates to inspection of workpieces and, more particularly, to semiconductor inspection.

### BACKGROUND OF THE DISCLOSURE

Evolution of the semiconductor manufacturing industry is placing greater demands on yield management and, in particular, on metrology and inspection systems. Critical dimensions continue to shrink, yet the industry needs to decrease time for achieving high-yield, high-value production. Minimizing the total time from detecting a yield problem to fixing it maximizes the return-on-investment for a semiconductor manufacturer.

Fabricating semiconductor devices, such as logic and memory devices, typically includes processing a semiconductor wafer using a large number of fabrication processes to form various features and multiple levels of the semiconductor devices. For example, lithography is a semiconductor fabrication process that involves transferring a pattern from a reticle to a photoresist arranged on a semiconductor wafer. Additional examples of semiconductor fabrication processes include, but are not limited to, chemical-mechanical polishing (CMP), etching, deposition, and ion implantation. An arrangement of multiple semiconductor devices fabricated on a single semiconductor wafer may be separated into individual semiconductor devices.

Inspection processes are used at various steps during semiconductor manufacturing to detect defects on wafers to promote higher yield in the manufacturing process and, thus, higher profits. Inspection has always been an important part of fabricating semiconductor devices such as integrated circuits (ICs). However, as the dimensions of semiconductor devices decrease, inspection becomes even more important to the successful manufacture of acceptable semiconductor devices because smaller defects can cause the devices to fail. For instance, as the dimensions of semiconductor devices decrease, detection of defects of decreasing size has become necessary because even relatively small defects may cause unwanted aberrations in the semiconductor devices.

As design rules shrink, however, semiconductor manufacturing processes may be operating closer to the limitation on the performance capability of the processes. In addition, smaller defects can have an impact on the electrical parameters of the device as the design rules shrink, which drives more sensitive inspections. Smaller defect sizes leads to a weaker defect signal and more candidates at the noise floor being flagged as defects. Controlling the number of defects on a workpiece may be difficult. Semiconductor manufacturers seek to determine if expected defects are present and, consequently, if process parameters are under control. Determining which of the defects influence the electrical parameters of the devices and the yield may allow process control techniques to be focused on those defects while largely ignoring others. Furthermore, at smaller design rules, process-induced failures, in some cases, tend to be systematic. That is, process-induced failures tend to fail at predetermined design patterns often repeated many times within the design. Elimination of spatially-systematic, electrically-relevant defects can have an impact on yield.

Current optical defect inspectors for IC devices rely on light reflection and scattering. As shown in FIG. 1, process noises are present at each fabrication step. While shown as rectangular in FIG. 1, the IC features can be irregular and rough. For logic devices, low-k dielectric material is used for middle end of the line (MEOL) and back end of the line (BEOL) as an inter-layer dielectric (ILD). Because low-k dielectric is optically transparent, light used for inspection travels across the layers and interacts with both the intended pattern structure and the process noises. As a result, the signal received by the detector from the wafer includes light returned from the intended pattern, process noises, and defects. As defects shrink in size, the cumulative light returned from noise sources in the stack overwhelms the inspection, which limits the defect detection sensitivity.

Techniques have been tried to enhance a signal to noise ratio (SNR) of the defect. Wavelength, illumination angle, polarization, and focus offset have been used to minimize process noise signal contribution and to maximize defect signal strength. Design information has been used to segregate wafer regions based on noise contribution, which allows quieter regions to have higher sensitivity. Filter optimization and algorithm parameter tuning have been used to maximize defect and wafer noise differentiation. Different optics modes have been used to differentiate process noise from defects so that noise can be filtered for higher sensitivity.

The current SNR enhancement and noise suppression techniques tend to work when defects have differentiable characteristics from wafer noise, either through optical mode selection, design region identification, or image morphology. However, it is challenging to use these noise suppression techniques when defect size decreases. When defect strength is close to or below wafer noise level, it may not be feasible to use optical mode optimization to differentiate defects from wafer noise. As defect size decreases, the signal generated from process noises in all regions becomes on par or sometimes even stronger than that from defects. Using design care areas and focusing defect detection at a quietest region also becomes ineffective. As signals of noise sources overwhelm the defect signal, algorithm tuning also becomes unmanageable because defect information is lost in the images swamped by wafer noise. Inspection combining multiple optics mode data also faces challenges when the defect signal is on par or weaker than wafer noise due to insufficient optical information for selecting optical modes to differentiate defects from wafer noise.

Thus, when a defect signal is on par or below the process noise, current techniques may not be sufficient. New optical methods to generate additional signal to boost the defect signal are needed.

### BRIEF SUMMARY OF THE DISCLOSURE

A method is provided in a first embodiment. The method includes disposing a workpiece on a stage in an optical inspection system. The workpiece includes a low-k dielectric material. A beam of light is generated with a wavelength from 190 nm to 900 nm. The beam of light is directed at the workpiece thereby causing fluorescence emission from the low-k dielectric material. The workpiece is imaged during fluorescence emission. The imaging uses an optical filter in an imaging path of the beam of light. The optical filter selects at least one wavelength from 300 nm to 900 nm.

The workpiece can be a semiconductor wafer. In an instance, the low-k dielectric material is a dielectric oxide.

The method can include quantifying a k-value of the low-k dielectric material based on the spectral shape and/or intensity level of the fluorescence emission using a processor.

The method can include determining uniformity of a k-value of the low-k dielectric material using a processor.

The method can include inspecting the low-k dielectric material for defects using a processor. In an instance, the workpiece further includes a metal and all of the signal used for the inspecting is from the low-k dielectric material. The metal may not have fluorescence emission during the directing.

The method can include tuning the wavelength between a first value from 190 nm to 700 nm and a second value from 300 nm to 900 nm using the optical filter.

A system is provided in a second embodiment. The system includes a light source configured to generate a beam of light at a wavelength from 190 nm to 900 nm; a stage configured to hold a workpiece in a path of the beam of light; a tunable optical filter in the path of the beam of light; a detector that receives the beam of light reflected from the workpiece; and a processor in electronic communication with the detector. The workpiece includes a low-k dielectric material. The beam of light causes fluorescence emission from the low-k dielectric material. The processor is configured to generate an image of the workpiece that includes the fluorescence emission.

The workpiece can be a semiconductor wafer. In an instance, the low-k dielectric material is a dielectric oxide.

The processor can be configured to quantify a k-value of the low-k dielectric material based on the spectral shape and/or intensity level of the fluorescence emission.

The processor can be configured to determine uniformity of a k-value of the low-k dielectric material.

The processor can be configured to inspect the low-k dielectric material for defects.

The tunable optical filter can be configured to tune the wavelength between a first value from 190 nm to 700 nm and a second value from 300 nm to 900 nm.

The system can include a polarizer in the path of the beam of light. The polarizer can be configured to tune a polarization of the beam of light.

The system can include a collection optical filter in a path of the beam of light between the stage and the detector. The collection optical filter can be configured to be tunable between 400 nm and 900 nm.

### DESCRIPTION OF THE DRAWINGS

For a fuller understanding of the nature and objects of the disclosure, reference should be made to the following detailed description taken in conjunction with the accompanying drawings, in which:

FIG. 1 is a cross-sectional view of a typical back end of line (BEOL) IC stack with structures representing metal lines (Mₓ) and interlayer dielectric (ILDₓ) with surface roughness and irregular metal structures;

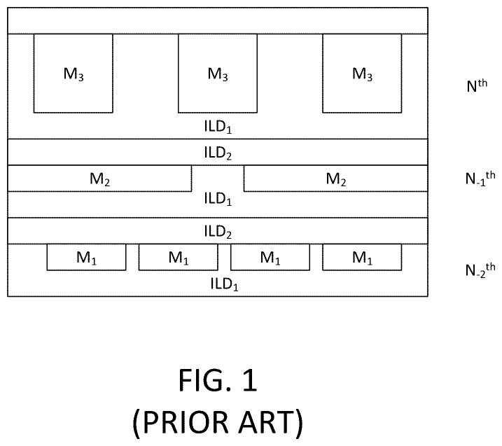

FIG. 2 is a schematic diagram of an embodiment of an optical system in accordance with the present disclosure;

FIG. 3 is a chart showing excitation spectrum (dashed line) capable of generating 550 nm fluorescence emission and the fluorescence emission spectrum (solid line) produced by 400 nm excitation light for a low-k dielectric material; and

FIG. 4 is a chart showing fluorescence emission spectra of two low-k dielectric material, k=2.55 and k=3.0, which shows that the intensity differences and the spectral shifts can be used to differentiate low-k material with different k-value target and to monitor the uniformity of k-value of the dielectric used in IC devices.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

Fluorescence emission from low-k dielectric materials can provide an improved imaging mode for signal generation that can enhance the sensitivity to defects. Embodiments disclosed herein capture the fluorescence emission of a low-k dielectric material to enhance optical inspection sensitivity for layers containing low-k dielectric. This fluorescent behavior in the low-k dielectric material enables a new signal generation mechanism to enhance the defect detection for layers containing low-k dielectric material. Furthermore, intensity and fluorescent emission spectrum change with different low-k dielectric materials. This optical property can be used to differentiate low-k dielectric materials and provide qualification uniformity of the k-value. The k-value of a dielectric material impacts the electrical performance of logic devices, so the ability to use fluorescence emission to monitor the k-value of the dielectric in the devices can be used to control the electrical performance of the IC and can result in higher yield.

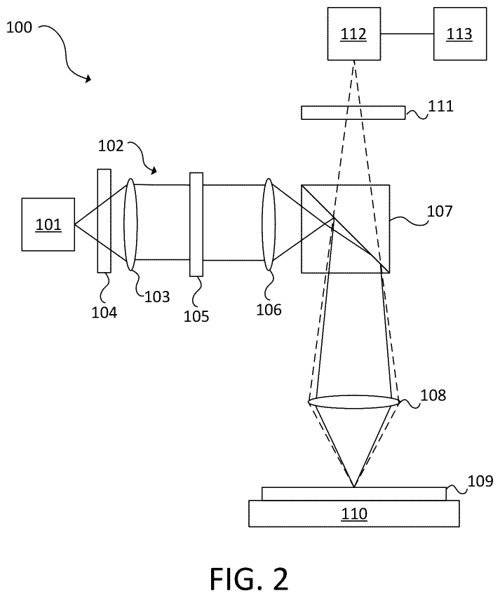

FIG. 2 is a schematic diagram of an embodiment of an optical system 100. The system 100 can provide a single mode or multi-mode inspection scheme. The optical system 100 can include fluorescence mode imaging.

The system 100 includes a light source 101 that generates a beam of light 102. The light source 101 can be, for example, a mercury source, laser source, lamp, laser-sustained plasma source, or other light sources. The beam of light 102 can have a wavelength from 190 nm to 900 nm. For example, the beam of light 102 can have a wavelength from 190 nm to 700 nm. As the beam of light 102 is projected along its path, the beam of light 102 can pass through a tunable optical filter 104, a first lens 103, a polarizer 105, and a second lens 106. While shown before the first lens 103 with respect to the path of the beam of light 102, the tunable optical filter 104 also can be positioned between the first lens 103 and the beam splitter 107.

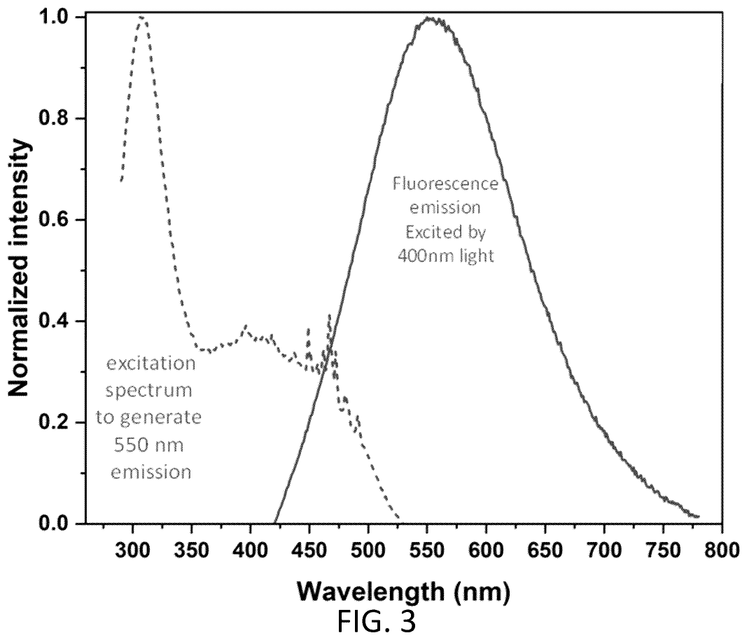

The wavelength ranges of the tunable optical filter 104 in the path of the beam of light 102 can be chosen so that a low-k dielectric material can be maximally excited to pump the fluorescence emission. The collection optical filter 111 in the imaging path then can be chosen to collect the maximum fluorescence emission from the low-k dielectric material. FIG. 3 shows the excitation and fluorescence emission spectra obtained from an exemplary low-k dielectric material. The strongest excitation wavelength in this example is around 310 nm, and the strongest fluorescence emission is around 550 nm.

Turning back to FIG. 2, the tunable optical filter 104 can tune the wavelength or wavelengths between a first value from 190 nm to 700 nm and a second value from 300 nm to 900 nm. For example, the tunable optical filter 104 can include several optical filters. A specific optical filter can be selected from the tunable optical filter 104 for a particular application or workpiece.

The polarizer 105 can tune a polarization of the beam of light 102. To reduce prior layer noise, the polarizer 105 can control the light penetration inside the workpiece 109. The polarizer 105 can limit light interaction to the surface of workpiece 109 to further reduce in noise in the fluorescence mode. Limiting light interaction can help if the workpiece 109 includes a wafer stack.

The beam of light 102 is directed at a beam splitter 107. After passing through the beam splitter 107 and a third lens 108, the beam of light 102 is directed at a workpiece 109. The workpiece 109 is disposed on a stage 110 configured the hold the workpiece 109 in a path of the beam of light 102.

The workpiece 109 may be a semiconductor wafer, though other workpieces are possible. In an instance, the workpiece 109 is a wafer stack. The workpiece 109 includes a low-k dielectric material, such as a dielectric oxide. The beam of light 102 causes fluorescence emission from the low-k dielectric material in the workpiece 109. For example, the low-k dielectric material that fluoresces may have a k-value below 3, but other low-k materials with different k-values that provide the same effect are possible.

A detector 112, such as a camera, receives the beam of light 102 reflected from the workpiece 109 (which is shown in dotted lines). The beam of light 102 may pass through a collection optical filter 111 along the path between the workpiece 109 and the detector 112. The collection optical filter 111 can be configured to be tunable to a wavelength or wavelengths between 400 nm and 900 nm. The collection optical filter 111 can include several optical filters. A specific optical filter can be selected from the collection optical filter 111 for a particular application or workpiece.

A processor 113 is in electronic communication with the detector 112. The processor 113 can be programmed in software and/or firmware to carry out the functions that are described herein, along with suitable digital and/or analog interfaces for connection to the other elements of system 100. Alternatively or additionally, the processor 113 can include hard-wired and/or programmable hardware logic circuits, which carry out at least some of the functions of the processor 113. Although the processor 113 is shown in FIG. 2, for the sake of simplicity, as a single, monolithic functional block, in practice the processor 113 may comprise multiple, interconnected control units, with suitable interfaces for receiving and outputting the signals that are illustrated in the figures and are described in the text. Program code or instructions for the processor 113 to implement various methods and functions disclosed herein may be stored in readable storage media, such as a memory.

The processor 113 is configured to generate an image of the workpiece 109 that includes the fluorescence emission using information from the detector 112. The processor 113 also can include additional functionality. For example, the processor 113 can be configured to quantify a k-value of the low-k dielectric material of the workpiece 109 based on the spectral shape and/or intensity level of the fluorescence. In another example, the processor 113 can be configured to determine uniformity of a k-value in the low-k dielectric material of the workpiece 109, such as by monitoring if the fluorescence intensity at a particular wavelength is below a threshold. In yet another example, the processor 113 can be configured to inspect the low-k dielectric material in the workpiece 109 for defects.

During operation, the workpiece 109 is positioned on the stage 110 in the system 100. The workpiece 109 is illuminated with the beam of light 102, which can have a wavelength from 300 nm to 900 nm. Illuminating the workpiece 109 with the beam of light 102 can cause fluorescence emission from the low-k dielectric material in the workpiece 109. The workpiece 109 is then imaged during this fluorescence emission.

Low-k dielectric fluorescence emission can be used to inspect the workpiece 109 in the fluorescence mode. Material on the workpiece 109 that does not fluoresce will not generate unwanted noise. For example, the MEOL and BEOL material of advanced logic devices include a dielectric and a metal. In the fluorescence mode, since only dielectric material fluoresces, the noise source generated from the metal lines are automatically suppressed, leading to noise reduction. Additionally, because the only signal from the wafer stack that emits signal is the low-k dielectric material, an oxide etch defect can have amplified signal generation in the fluorescence mode. This can result in higher defect signal and enhanced defect detection.

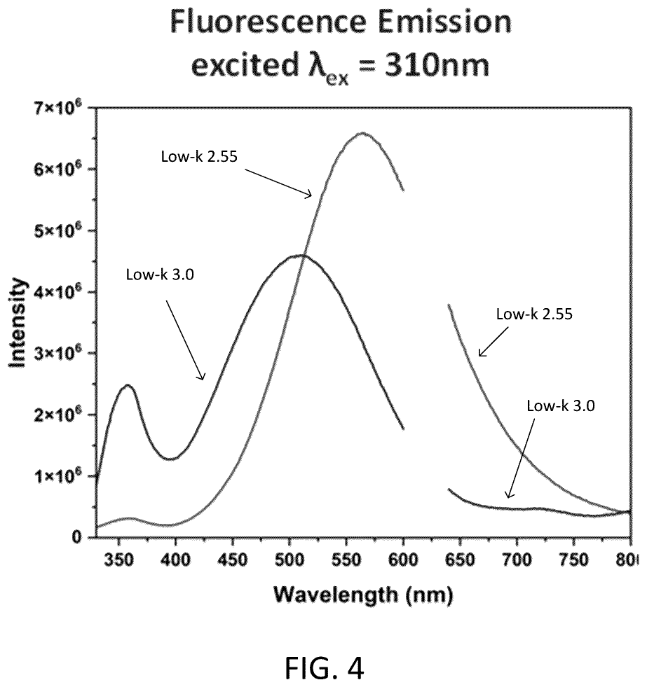

FIG. 4 shows emission spectra of k=2.55 and k=3.0 low-k dielectric material. The difference in the spectral response can be used to quantify the k-value and check the uniformity of low-k dielectric. Embodiments of the system disclosed herein can be used to determine whether the low-k dielectric material meets the k-value specification and can quantify uniformity of the k-value over an entire surface or part of a surface of the workpiece 109.

In an embodiment, the fluorescence mode can use the light source 101 with the tunable optical filter 104 covering 190-700 nm in the illumination path to deliver excitation light to the workpiece 109 and the collection optical filter 111 in the imaging path covering 400-900 nm to collect fluorescence emission from the dielectric material. To further control light transmission in the workpiece 109 (e.g., in a wafer stack) for noise control, the polarizer 105 can be used. The fluorescence mode of the system 100 captures a signal that can provide a higher defect sensitivity with low-k dielectric material qualification applications. For example, for defect inspection, the fluorescence mode of the system 100 will provide additional signals for defects on layers where low-k dielectric material is used. In another example, the system 100 can quantify and monitor uniformity of k value for a low-k dielectric in the workpiece 109. In yet another example, the intensity and the fluorescence emission spectra can be used to (1) differentiate low-k dielectric material with different target k-value and to (2) monitor k-value uniformity of the low-k dielectric material in the workpiece 109.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A method comprising:
disposing a workpiece on a stage in an optical inspection system, wherein the workpiece includes a low-k dielectric material;
generating a beam of light with a wavelength from 190 nm to 900 nm;
directing the beam of light at the workpiece thereby causing fluorescence emission from the low-k dielectric material;
imaging the workpiece during fluorescence emission, wherein the imaging uses an optical filter in an imaging path of the beam of light, and wherein the optical filter selects at least one wavelength from 300 nm to 900 nm.

2. The method of claim 1, wherein the workpiece is a semiconductor wafer.

3. The method of claim 1, wherein the low-k dielectric material is a dielectric oxide.

4. The method of claim 1, further comprising quantifying a k-value of the low-k dielectric material based on a spectral shape and/or intensity level of the fluorescence emission using a processor.

5. The method of claim 1, further comprising determining uniformity of a k-value of the low-k dielectric material using a processor.

6. The method of claim 1, further comprising inspecting the low-k dielectric material for defects using a processor.

7. The method of claim 6, wherein the workpiece further includes a metal, and wherein all of the signal used for the inspecting is from the low-k dielectric material.

8. The method of claim 7, wherein the metal does not have fluorescence emission during the directing.

9. The method of claim 1, further comprising tuning the wavelength between a first value from 190 nm to 700 nm and a second value from 300 nm to 900 nm using the optical filter.

10. A system comprising:
a light source configured to generate a beam of light at a wavelength from 190 nm to 900 nm;
a stage configured to hold a workpiece in a path of the beam of light, wherein the workpiece includes a low-k dielectric material, and wherein the beam of light causes fluorescence emission from the low-k dielectric material;
a tunable optical filter in the path of the beam of light;
a detector that receives the beam of light reflected from the workpiece; and
a processor in electronic communication with the detector, wherein the processor is configured to generate an image of the workpiece that includes the fluorescence emission.

11. The system of claim 10, wherein the workpiece is a semiconductor wafer.

12. The system of claim 10, wherein the low-k dielectric material is a dielectric oxide.

13. The system of claim 10, wherein the processor is configured to quantify a k-value of the low-k dielectric material based on a spectral shape and/or intensity level of the fluorescence emission.

14. The system of claim 10, wherein the processor is configured to determine uniformity of a k-value of the low-k dielectric material.

15. The system of claim 10, wherein the processor is configured to inspect the low-k dielectric material for defects.

16. The system of claim 10, wherein the tunable optical filter is configured to tune the wavelength between a first value from 190 nm to 700 nm and a second value from 300 nm to 900 nm.

17. The system of claim 10, further including a polarizer in the path of the beam of light, wherein the polarizer is configured to tune a polarization of the beam of light.

18. The system of claim 10, further including a collection optical filter in a path of the beam of light between the stage and the detector, wherein the collection optical filter is configured to be tunable between 400 nm and 900 nm.
